(19) United States
(12) Patent Application Publication
(10) Pub. No.: US 2024/0388454 A1
(43) Pub. Date: Nov. 21, 2024

(54) SYSTEM AND METHOD FOR SECURING A MOBILE SERVICES ACCOUNT

(71) Applicant: Nova Labs, Las Vegas, NV (US)

(72) Inventors: James Dal Gemmell, San Jose, CA (US); Andrew Nelson Allen, Washington, DC (US); Andrew Thompson, Las Vegas, NV (US); Sze Wan Tang, San Jose, CA (US); Joseph Padden, Boulder, CO (US); Karishma Amin, Las Vegas, NV (US); Marc Edward Nijdam, Livingston, TX (US); Arsenii Oganov, Kyiv (UA); Dmyto Tsapko, Kyiv (UA); Boris Renski, Los Gatos, CA (US)

(73) Assignee: Nova Labs, Las Vegas, NV (US)

(21) Appl. No.: 18/665,430

(22) Filed: May 15, 2024

Related U.S. Application Data
(60) Provisional application No. 63/560,902, filed on Mar. 4, 2024.
(60) Provisional application No. 63/466,993, filed on May 16, 2023.

(51) Int. Cl. H04L 9/00; H04L 9/32

(52) U.S. Cl. CPC H04L 9/50; H04L 9/3242

(57) ABSTRACT

The disclosed technology relates to a system for securing account information using blockchain technology. The system links the configuration of a user's account to a blockchain wallet. Changes to the account configuration are pre-approved in a blockchain transaction signed by the owner's wallet private-key. The account configuration is hashed and stored on the blockchain. The system includes a monitoring component that periodically checks the status of account details and compares the hash on the blockchain with the hash of the current network observed configuration. If the hashes do not match, the system can disable the account. The system can be applied in various sectors including banking, healthcare, e-commerce, education, and government services.

### CROSS REFERENCE

The present application for patent claims the benefit of U.S. Provisional Patent Application No. 63/560,902, filed on Mar. 4, 2024, assigned to the assignee hereof, and which is hereby incorporated by reference in its entirety and claims the benefit of U.S. Provisional Patent Application No. 63/466,993, filed on May 16, 2023, assigned to the assignee hereof, and which is hereby incorporated by reference in its entirety.

### FIELD OF INVENTION

The present disclosure generally relates to the field of telecommunications, specifically focusing on the security of mobile services account configurations, and in particular, to a system and method for securing account information using secure attestable ledger technology to prevent unauthorized changes and enhance security.

### BACKGROUND

In the realm of telecommunications, mobile devices are typically associated with a Subscriber Identity Module (SIM) card. This SIM card contains a user's account information and enables the device to connect to a mobile network. The SIM card contains a number of identifiers, including the International Mobile Subscriber Identity (IMSI), which is a number that uniquely identifies every user of a mobile network, and the Integrated Circuit Card Identifier (ICCID), which is a serial number that identifies the physical SIM card itself. Additionally, the Mobile Station International Subscriber Directory Number (MSISDN) is used to identify a mobile phone number in the international public switched telephone network (PSTN).

### SUMMARY OF INVENTION

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to one or more aspects of the present disclosure, a system is provided for securing account information from unauthorized modifications by linking the account configuration to a secure attestable ledger. The system includes a user frontend and a backend, both capable of independently calculating a hash based on a user-requested configuration change. The frontend triggers the submission of an entry to the secure attestable ledger before passing the configuration change request to the backend. The backend, before applying the change, compares the hash it produces to the hash on the secure attestable ledger and applies the change to the account configuration if the hashes match. The secure attestable ledger is independent of the backend such that if the backend system is compromised the secure attestable ledger is unaffected thereby securing the user's account.

According to one or more aspects of the present disclosure, the system may include a monitoring system that periodically checks the status of account details using records, such as but not limited to Call Data Records (CDRs). The monitoring system can create the hash of the current network observed configuration and compare it to a prior network observed configuration hash stored on the secure attestable ledger. If the hashes do not match, the monitoring system can disable the account until rectification can occur, such as an investigation to identify the discrepancy.

According to one or more aspects of the present disclosure, the system includes a wallet connect step wherein before a change is made to the customer account settings or configuration, a secure attestable ledger transaction is performed with a hash of the desired configuration signed by the private-key associated with the account. Once the account owner's wallet has performed the secure attestable ledger transaction, the Carrier Admin backend checks the secure attestable ledger for the correct hash before executing. A failed check means the changes are not applied.

According to one or more aspects of the present disclosure, the system may include a process for monitoring the hourly CDRs delivered to a first provider (e.g., Nova Labs) from second provider (e.g., T-Mobile) to determine if unauthorized changes to a customer's account or plan have occurred. The monitor analyzes the CDR data over predetermined time intervals, such as on an hour-to-hour basis, and forms a list of any Mobile Station International Subscriber Directory Numbers (MSISDNs) that have changed configuration. The monitor uses the list and queries configuration data from Carrier Admin, then calculates new configuration hashes based on any updates from CDR data, for example, changes to MSISDN, International Mobile Subscriber Identity (IMSI), and/or Integrated Circuit Card Identification Number (ICCID). The monitor then queries the configuration hashes for the affected accounts from the secure attestable ledger and compares them. Any unauthorized changes may result in action being taken, for example, the account being suspended from service in a timely manner.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a sequence diagram depicting the process for a subscriber to exit lockdown mode after a security event, such as a SIM swap or device theft, according to aspects of the present disclosure.

FIG. 2 presents a high-level call flow for a user-initiated configuration change process within a secure account management system, according to aspects of the present disclosure.

FIG. 3 depicts a communication flow of the monitoring process for detecting unauthorized changes in mobile services account configurations, according to aspects of the present disclosure.

FIG. 4 shows a communication flow for handling a stolen device and initiating a lockdown mode, according to aspects of the present disclosure.

FIG. 5 illustrates a communication flow for switching a mobile device's SIM card, according to aspects of the present disclosure.

FIG. 6 presents a communication flow of a security process for monitoring and responding to potential unauthorized changes in a subscriber's account, according to aspects of the present disclosure.

FIG. 7 depicts a communication flow for managing account changes within a secure system, according to aspects of the present disclosure.

FIG. 8 shows a communication flow of the enrollment process for an Anti SIM Swap feature, according to aspects of the present disclosure.

FIG. 9 illustrates a communication flow for unenrolling a subscriber from an Anti SIM Swap feature, according to aspects of the present disclosure.

FIG. 10 depicts a flowchart of a method for securing account information using secure attestable ledger technology, according to aspects of the present disclosure.

FIG. 11 presents a flowchart of a method for securing account information using secure attestable ledger technology, with additional steps for monitoring the status of the account configuration, according to aspects of the present disclosure.

### DETAILED DESCRIPTION

The following description sets forth exemplary aspects of the present disclosure. It should be recognized, however, that such a description is not intended as a limitation on the scope of the present disclosure. Rather, the description also encompasses combinations and modifications to those exemplary aspects described herein.

Security is a paramount concern in the telecommunications industry, particularly with regard to protecting user account information from unauthorized access or modification. One common security threat is a SIM swap attack, where an attacker convinces a mobile network operator to switch the victim's phone number to a SIM card controlled by the attacker. Once this is done, the attacker can potentially gain access to various accounts linked to the victim's phone number, such as email or online banking accounts.

Blockchain technology has emerged as a potential solution for enhancing security in various domains, including telecommunications. A blockchain is a decentralized and distributed digital ledger that records transactions across multiple computers in such a way that the recorded transactions cannot be altered retroactively. This immutability property of blockchain technology makes it a promising tool for securing digital transactions and preventing fraud.

Non-Fungible Tokens (NFTs) are a type of cryptographic token on a blockchain that represent a uniquely identifiable object; unlike cryptocurrencies such as Bitcoin or Ethereum, which are fungible and can be exchanged on a one-for-one basis, NFTs are not interchangeable for other tokens because they contain identifying information recorded in their smart contracts. This makes NFTs particularly useful for verifying the authenticity and ownership of digital assets.

Furthermore, the use of digital wallets in blockchain transactions is a common practice. A digital wallet is a software-based system for making electronic transactions, which can include purchasing items online with a computer or smartphone, or making transactions on a blockchain. In the context of blockchain transactions, a digital wallet may also be used to store and manage a user's cryptographic keys.

The SecureAF system, in some aspects, is designed to enhance the security of telecommunication account information by preventing unintended modifications. This is achieved by associating user telecommunication account configuration with a blockchain via an interface. Blockchain interfaces are sometimes called “wallets”, although the present systems and methods are not leveraging the blockchain for cryptocurrency but instead utilizing the blockchains security aspects. As such both wallet and blockchain interface are used here interchangeably. The account configuration may include, but is not limited to, plan selection (base plan, features, promotions), billing information (payment method, billing address, shipping address), MSISDN (the phone number), IMSI (the subscriber network identity), ICCID (the SIM card hardware identity), owner wallet public-key, and opt-in/opt-out feature selections.

In some cases, the SecureAF system generates a hash of the account configuration and stores it on the blockchain as immutable data. This hash is signed by a private-key associated with the user's telecommunication account, providing an additional layer of security. In some embodiments the hash is of fixed length, regardless of the size of the input, and can be queried and compared to a requested configuration change. This process ensures that any changes to the account configuration are pre-approved in a blockchain transaction signed by the owner's wallet (blockchain interface) private-key.

When a request for a change to the account configuration is received, the SecureAF system generates another hash for the requested configuration change. This new hash is then compared with the hash stored on the blockchain. If the hashes match, the requested configuration change is applied to the telecommunication account configuration. This process ensures that any changes to the account configuration are pre-approved, thereby enhancing the security of the account information.

In some aspects, the SecureAF system also includes a monitoring system that periodically checks the status of user account details. This monitoring system can generate a hash of the current network configuration and compare it with the prior network configuration hash stored on the blockchain. If the hashes do not match, the monitoring system may, for example, disable the user account until an investigation can be carried out to identify why there is a discrepancy. Other actions may occur that are within the purview of the telecommunications operator. This feature provides an additional layer of security by detecting and responding to unauthorized changes in a timely manner.

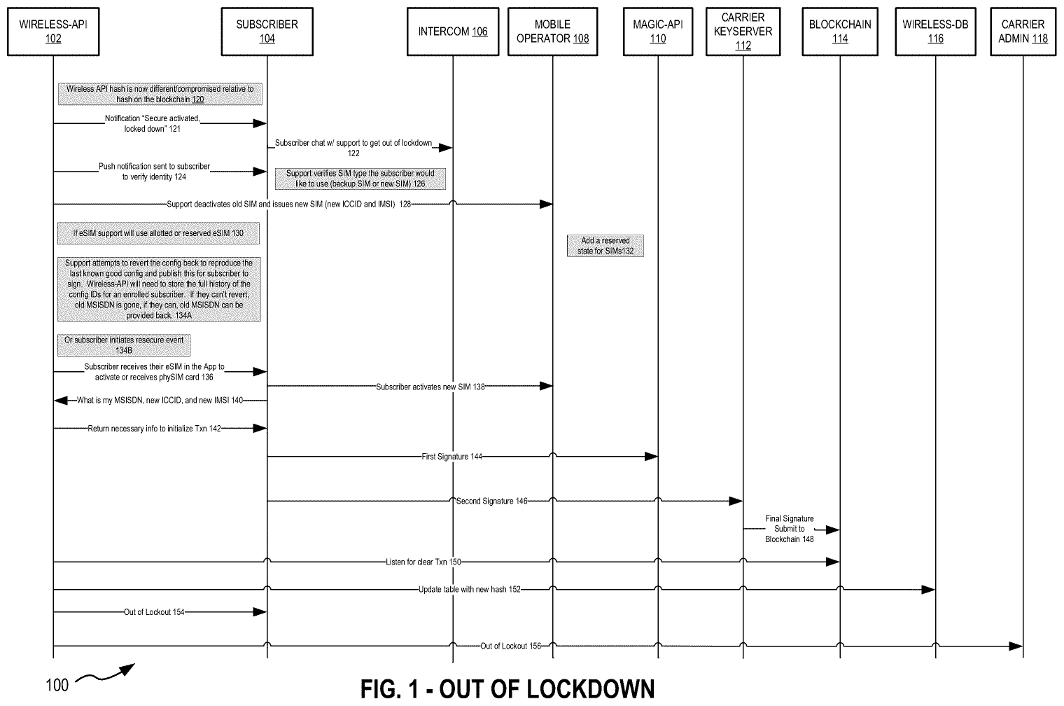

FIG. 1 depicts a communication flow 100 illustrating the process for a mobile services account to exit a lockdown mode.

A Wireless-API 102 initiates flow 100, leading to interaction with a Subscriber 104. An Intercom Communication Interface 106 facilitates dialogue between the Subscriber 104 and a Mobile Operator 108, while the Magic-API 110 and Carrier Keyserver 112 are involved in authentication operations. Blockchain 114 ensures the integrity of the process through blockchain technology, with a Wireless Database 116 maintaining a table of hashes and Carrier Administrator 118 performs the final out of lockout process for Subscriber 104 via the Wireless-API 102, i.e., Wireless Database 116 records the event, which eventually leads to the Carrier Administrator 118 updating lockdown status, which reflects changes in the account's lockdown status.

Looking at the communication flow, associated systems recognize, at state 120, that the Wireless-API Hash is difference or compromised relative to that stored on the Blockchain 114. Wireless-API 102 sends a “Secure activated, locked down” notification 121 to Subscriber 104 to inform then an issue was detected, and their device is in lockdown. Subscriber 104 then communicates 122 with Operator Intercom 106 to initiate an end lockdown process. A Push notification 124 sent to Subscriber 104 to verify the identity of Subscriber 104, followed by Support verifying the SIM type Subscriber 104 would like to use, for example, a backup SIM or new SIM in step 126. The old SIM deactivation and new SIM activation 128 manages the transition from the compromised SIM to a new SIM card, for example with new ICCID and IMSI. If the subscribers utilized an eSIM then step 130 pulls an eSIM, for example, from a reserve set of eSIM. In step 132 the operator adds a reserved SIM state, managing the receipt and activation of new eSIMs. Optionally, operator initiated recovery 134A and subscriber initiated recovery 134B outline the steps for a subscriber to exit lockdown mode. In step 134A operator support attempts to revert the configuration back to the last known good hash and publish this for Subscriber 104 to sign. This may require the wireless-API to store the full history of the configuration IDS for an enrolled subscriber. If reverting to the last known good hash, then the old MSISDN is gone. If the system can revert, then the old MSISDN can be provided back. In optional step 134B a subscriber initiates the rescue event or recovery.

New SIM, including one of a physical SIM (pSIM or phySIM) and an eSIM, is received in step 136 (either physically or electronically) and in new SIM activation step 138 brings the new SIM into service. The subscriber initiated step 140 requests the MSISDN, ICCID, and IMSI from the wireless API which in response returns necessary information to initialize transactions, provided in the Initialization Information Return 142 step. The first signature to magic-API 144 and second signature to Operator Keyserver 146 rely on data received in step 142 and authenticate the process, which leads to a submission, to Blockchain 114, of the final signature from keyserver 148, which ensures the transaction is recorded on the blockchain.

The hash update 152 outlines the steps for updating the security hash at Wireless Database 116, with the out of lockdown signal 154 from the Wireless-API 102 to Subscriber 104 indicating the account's exit from lockdown mode. Finally, the subscriber lockdown status update to Operator 156 reflects the updated status of the subscriber's account as they exit lockdown mode.

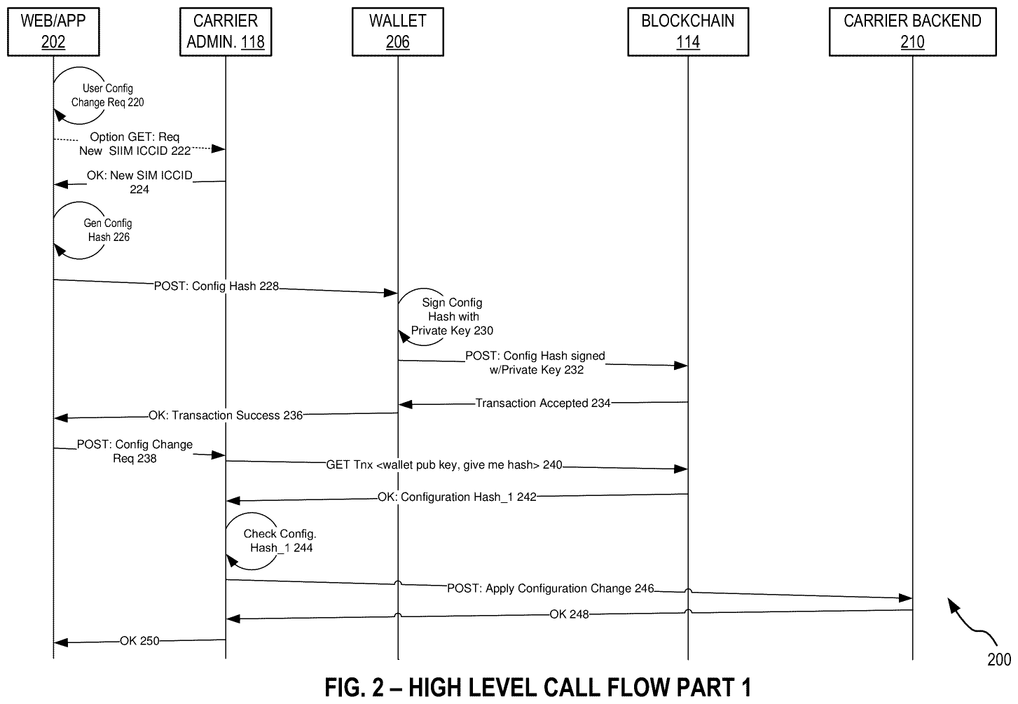

FIG. 2 shows a high-level call flow/communication flow 200 for a user-initiated configuration change process within a secure account management system.

Flow 200 begins with a Web/App 202, where a User Configuration Change Request 220 is generated. This request can optionally be packed in a GET request for a new SIM ICCID 222 from the Carrier Administrator 118, which generates a response with an OK message confirming the new SIM ICCID 224 for Web/App 202. Web/App 202 then generates 226 a Configuration Hash based at least in part on the received SIM ICCID message 224. Web/App 202 then sends a POST 228 with the generated Configuration Hash to the Wallet 206, which signs the Configuration Hash with a private key 230 and POSTs 232 the Configuration Hash signed by the private-key to Blockchain 114. Upon successful transaction acceptance, indicated by a Txn Accepted message 234, Wallet 206 confirms the transaction success back to Web/App 202 with an OK message 236.

Subsequently, Web/App 202 sends a POST request for a Configuration Change Request 238 message to Carrier Administrator 118, which then retrieves the transaction information from Blockchain 114 using a GET request 240 for the transaction with the wallet public-key and the corresponding hash. Blockchain 114 responds with an OK message 242 providing Configuration Hash 1. Carrier Administrator 118 checks Configuration Hash 1 244 and, if verified, sends a POST request to Apply Configuration Change 246 to Carrier Backend 210. Carrier Backend 210 completes the process by sending an OK confirmation 248 back to the Carrier Administrator 118, which then relays an OK message 250 to the Web/App 202, indicating the successful application of the configuration change.

In some variations, the SecureAF system may use different types of wallets to sign transactions on the blockchain. For example, the system could be implemented using a software wallet, a hardware wallet, or a paper wallet. Additionally, the wallet could be hosted on the user's device, on a remote server, or on a decentralized network. Each of these variations could offer different levels of security, convenience, and user control.

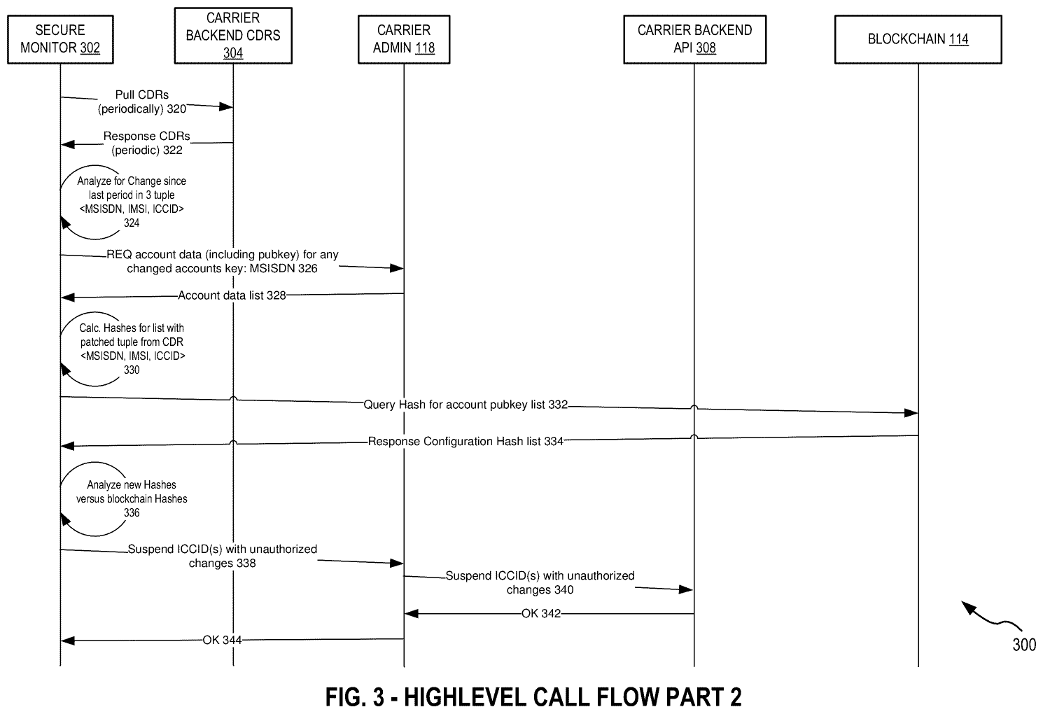

Referring to FIG. 3, the SecureAF monitoring process 300 for detecting unauthorized changes in mobile services account configurations is depicted.

A SecureAF Monitor 302 initiates the process by pulling Call Data Records (CDRs) 320 hourly from a Carrier Backend CDRs 304. Carrier Backend CDRs 304 respond with the CDRs 322, which the SecureAF Monitor 302 analyzes for changes in the tuple <MSISDN, IMSI, ICCID>324. In some cases, the SecureAF Monitor may use different methods to detect changes, such as polling, event-driven notifications, finger printing, or machine learning algorithms. Each of these variations could offer different levels of accuracy, performance, and scalability.

Upon detecting changes, the SecureAF Monitor requests account data 326, including public keys, for any changed accounts from the Carrier Administrator 118. Carrier Administrator 118 provides an account data list 328, which SecureAF Monitor 302 uses to calculate hashes for the list with patched tuple from the CDR 330. SecureAF Monitor 302 then queries the Blockchain 114 for the hash corresponding to the account public-key list 332. The Blockchain responds with the configuration hash list 334.

The SecureAF Monitor 302 analyzes the new hashes against the blockchain hashes 336. If unauthorized changes are detected, represented by a discrepancy between the new hashes and the blockchain hashes, the SecureAF Monitor 302 instructs the Carrier Administrator 118 to suspend the affected ICCID(s) 338. The suspension is then executed 340 by a Carrier Backend API 308. Carrier Backend API 308 confirms the suspension with an “OK” 342 response to the SecureAF Monitor 302, completing the process. Carrier Backend API 308 is an API into Carrier Backend 210.

In some variations, the SecureAF system may use a centralized server, a decentralized network, or a hybrid approach for the monitoring system. The choice of monitoring system could affect the accuracy, performance, and scalability of the SecureAF system. This variation could be applicable to any of the steps involving the generation or comparison of hashes.

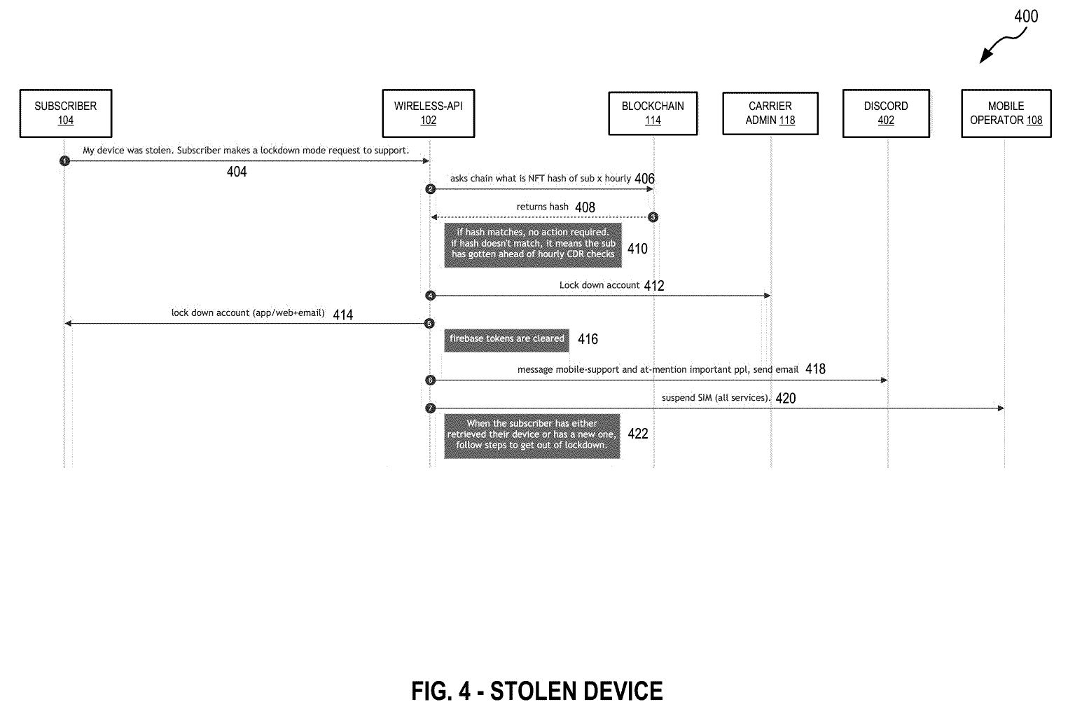

FIG. 4 shows a communication flow 400 for handling a stolen device and initiating a lockdown mode.

In some cases, a lockdown mode request 404 is made by Subscriber 104 to the Wireless-API 102. This request triggers a blockchain hash inquiry 406 to a secure attestable ledger, Blockchain 114, such as but not limited to a Solana Blockchain. One example of step 406 is Wireless-API 102 request from Blockchain 114 for an NFT has of sub on a periodic basis, e.g., hourly. The secure attestable ledger could be a public blockchain, a private blockchain, or a consortium blockchain, and could be implemented using different blockchain protocols, such as Bitcoin, Ethereum, Hyperledger Fabric, or a new blockchain protocol, depending on the desired levels of security, performance, and decentralization.

The blockchain returns 408 the requested hash to Wireless-API 102. In step 410 a hash match is determined, i.e., the Wireless-API determines if the retrieved hash from Blockchain 114 matches the hash Wireless-API 102 has access to. A hash match condition indicates that if the hash matches, no action is taken. However, if there is a discrepancy, it suggests that the subscriber's account may have been compromised, and the account lockdown action 412 is initiated. This involves locking down the subscriber's account, for example, across various platforms, potentially impacting app, web, and email. Wireless-API 102 informs Subscriber 104 in step 414 their account is locked down. Optionally, firebase token clearance occurs in step 416, which involves clearing Firebase tokens associated with the subscriber's account to further secure the account.

A support notification action 418 is then taken, which involves alerting mobile support and relevant personnel via Discord 402. Mobile Operator 108 is instructed to suspend the SIM for all services, represented by the SIM deactivation in step 420. The subscriber may receive an email/notification/push notification stating “SecureAF activated, locked down.” When the subscriber either retrieves their device or acquires a new device the subscriber may then follow the “out of lockdown” process 422, one example of which is shown in FIG. 1.

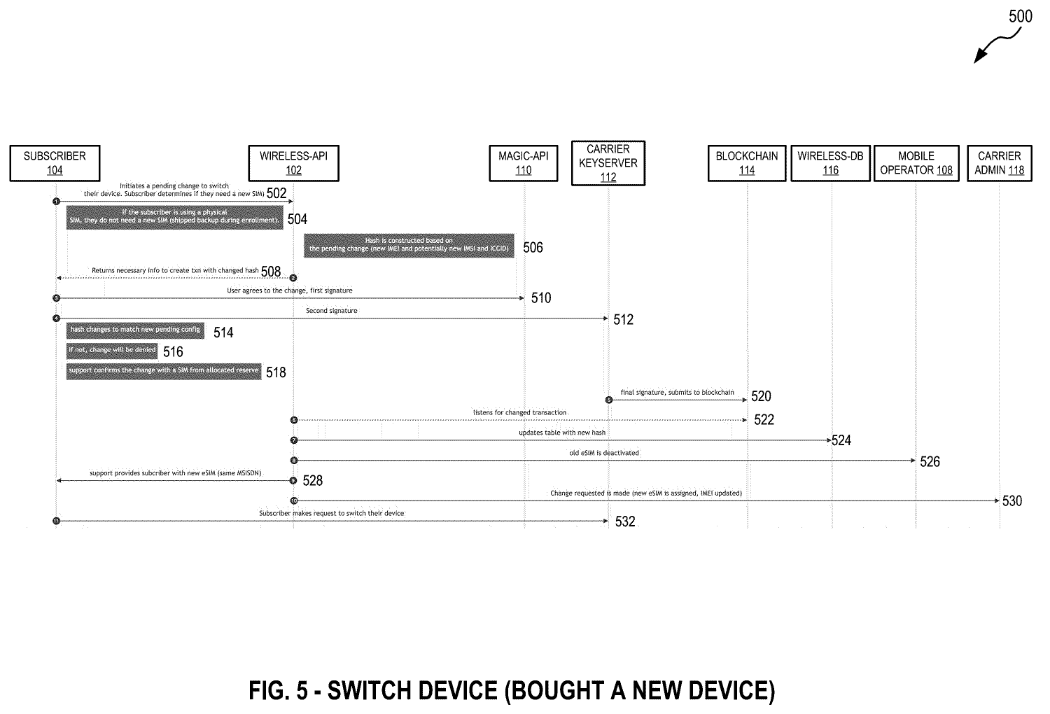

FIG. 5 shows a communication flow 500 for managing account changes within a secure system. Communication flow 500 begins with a lockdown mode request 502, where Subscriber 104 initiates a pending change to their account, for example, the subscriber switches to a new device. If Subscriber 104 uses a physical SIM a new SIM is not need as they are shipped a backup during enrollment, as described at 504. In step 506 a hash is constructed based on the pending change, and the blockchain hash inquiry 508 sends back the information to Subscriber 104 to create a transaction with the changed hash.

In step 510 Subscriber 104 agrees to the change and provides a first signature to the Magic-API 110. In step 512 Subscriber 104 sends a second signature to the Carrier Keyserver 112. Step 514 ensures the hash change matches ne pending configuration. If the hash does not match, the change will be denied 516. If the hash change matches the new pending configuration the system support confirms the change with a SIM from allocated reserve 518. In step 520, Carrier Keyserver 112 submits the final signature to the Blockchain 114.

In step 522 Wireless-API 102 listens for a changed transaction then updates the Wireless Database 116 table with the new hash in step 524 and the old eSIM is deactivated in step 526 via a communication between the Wireless-API 102 and the Mobile Operator 108. In step 528 Wireless-API 102 provides a support-supplied eSIM (having the same MSISDN). In step 530, Wireless-API 102 sends the approved change to Carrier Administrator 118, e.g., the new eSIM is assigned and IMEI is updated. In the final step 532, Subscriber 104 sends a request to switch device to Carrier Keyserver 112.

In some variations, the SecureAF system may use different hashing algorithms to generate the hash of the account configuration. For example, the system could be implemented using SHA-256, SHA-3. Blake2, or any other secure hashing algorithm. The choice of hashing algorithm could affect the security and performance of the system.

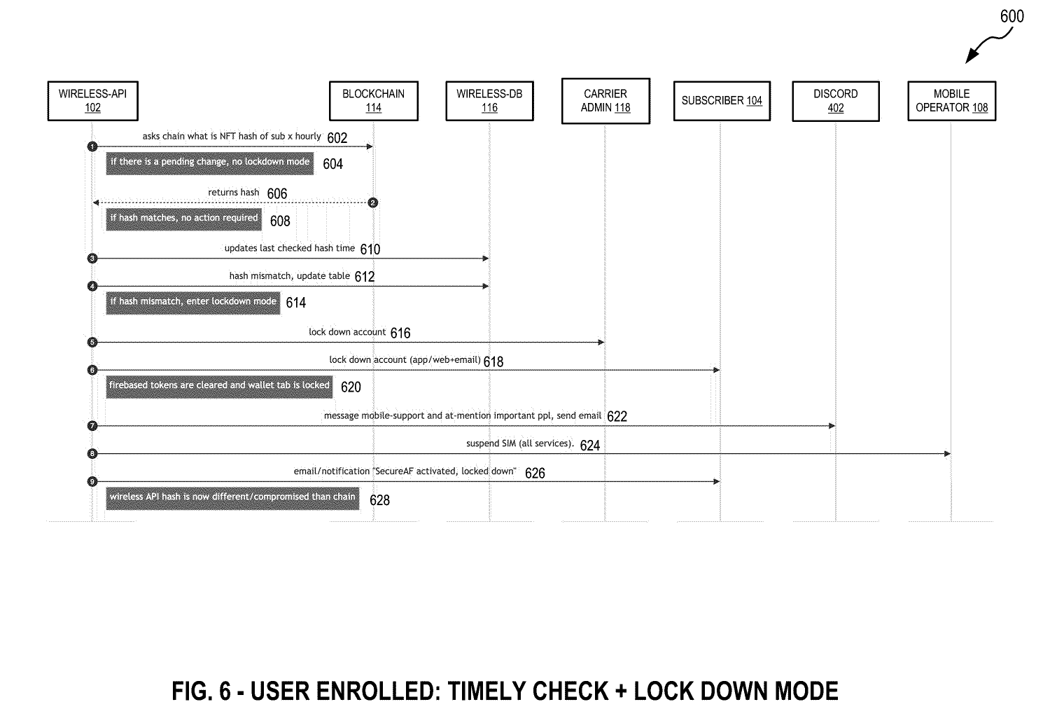

FIG. 6 shows a communication flow 600 for an Anti SIM Swap feature within the SecureAF system.

This process performs a periodic check which may initiate a lock down if the check determines there is a mismatch between hashes. The process begins with Wireless-API 102 performing a periodic (e.g., hourly) request 602 for a hash associated with subscriber information (e.g., account information) from Blockchain 114. If the method determines there is a pending change, then lockdown mode is not utilized, as in step 604.

Blockchain 114 returns the hash to Wireless-API 102 in step 606 based on the request. If the blockchain-retuned hash matches the Wireless-API 102 hash no action is required. If the Blockchain 114 returned hash matches wireless-API 102's hash no action is taken as in step 608. Wireless-API may update the last checked has time at the Wireless Database 116 in step 610.

If the Blockchain 114 returned hash does not match wireless-API hash then step 612 updates the Wireless Database 116 table and enters lockdown mode in step 614, and Wireless-API 102 sends a lockdown account message to Carrier Administrator 118 in step 616 and to Subscriber 104 in step 618. In optional step 620, Firebased tokens are cleared, and the wallet is locked.

At step 622 Wireless-API 102 sends a support notification, which involves alerting mobile support and relevant personnel via Discord 402. Wireless-API 102 in step 624 sends a “suspend SIM (all services)” message to Operator 108 and, in step 626, a message notifying Subscriber 104 the account is locked down. Lockdown is based on the determination, via the periodic check, that the Wireless-API 102 hash is different from that on the chain as shown in step 628.

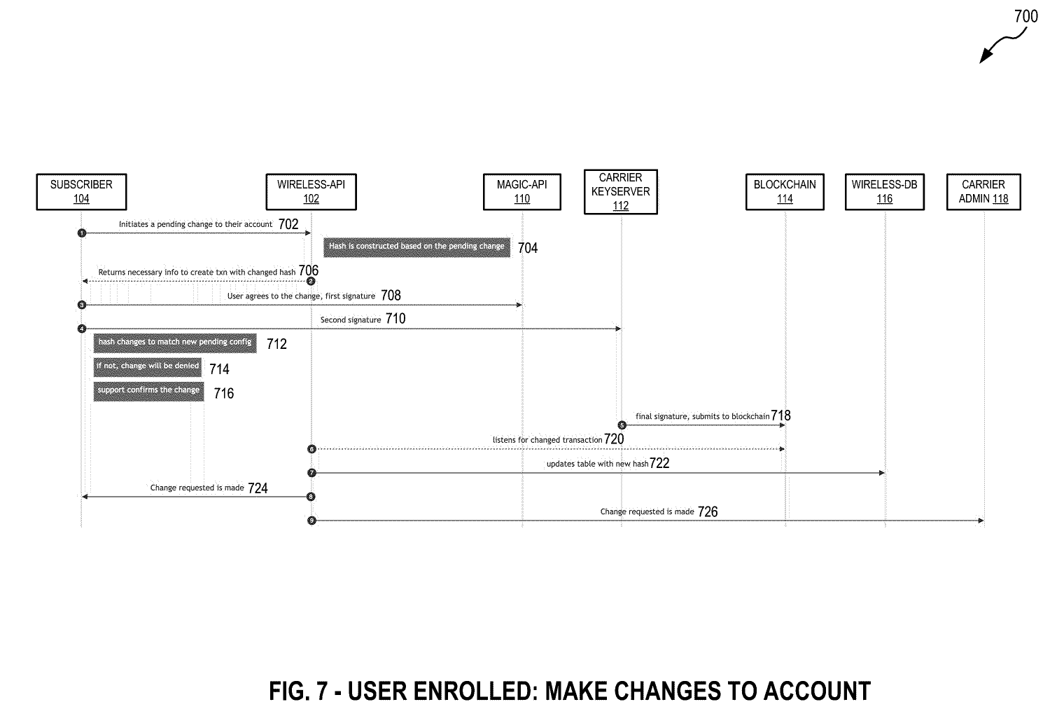

FIG. 7 shows a communication flow 700 for unenrolling a subscriber from an Anti SIM Swap feature within the SecureAF system.

Communication flow 700 begins with a request 702 from Subscriber 104 to Wireless-API 102, where Subscriber 104 initiates a pending change to their account. This query is made to Wireless-API 102, which, in an embodiment, is a component of the SecureAF system responsible for managing aspects of wireless communication services. In step 704 a hash is calculated based on the pending change. Wireless-API 102 then returns the necessary information to create the transaction with the changed hash in communication step 706.

Subscriber 104 then sends, in step 708, a “user agrees” message with a first signature to Magic-API 110, and in step 710 sends a second signature to Carrier Keyserver 112. The hash changes need to match the new pending configuration and is determined in step 712. If not, the changes are denied in step 714. If hashes match, support (not shown here) confirms the change in step 716.

In step 718 Carrier Keyserver 112 sends a final signature and submits it to Blockchain 114. Wireless-API 102 listens for change transactions at Blockchain 114 in step 720 and updates the table in Wireless Database 116 with the new hash in step 722, then informs Subscriber 104 in step 724 and the Carrier Administrator 118 in step 726 that the requested change request has been made.

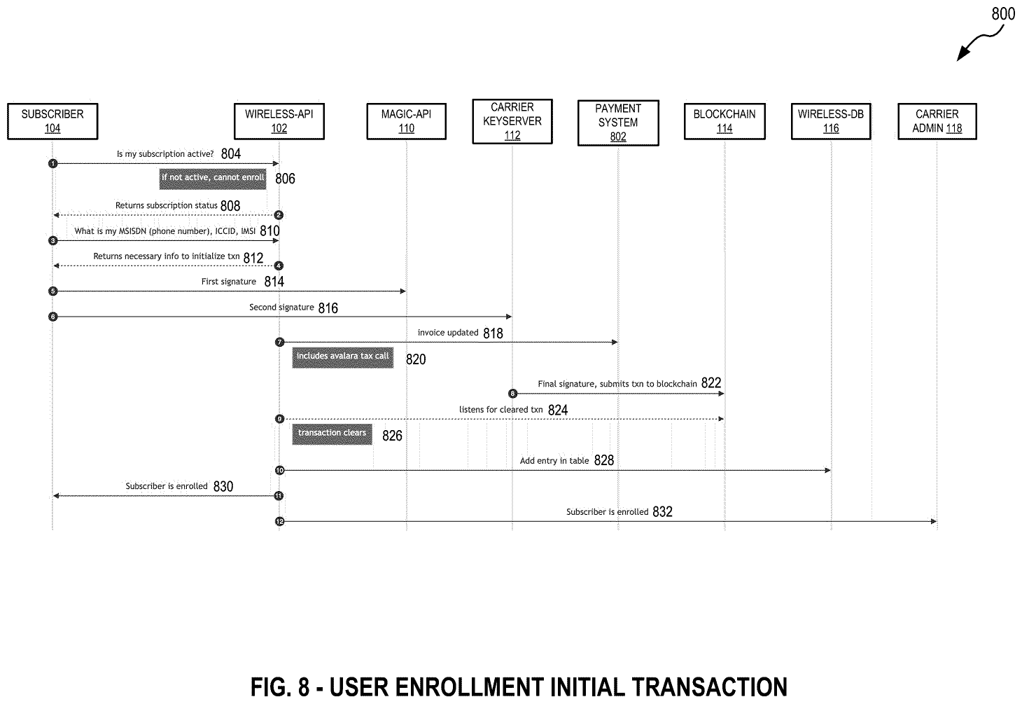

FIG. 8 shows a communication flow 800 for an initial transaction for user enrollment.

FIG. 8 includes a Payment System 802 which may be used to resolve payments and tax calls. One example of a Payments System 802 is Stipe©.

Communication flow 800 starts with the subscriber checking with the wireless-API if their account is active in step 804. If the account is not active the flow ends, as in step 806. If the account is active, then the flow returns the subscription status in step 808. In step 810 Subscriber 104 requests their MSISDN, ICCID and IMSI from Wireless-API 102 which is returned to Subscriber 104 in step 812. Subscriber 104 then sends a first signature, in step 814, and a second signature, in step 816, to the Magic-API 110 and Carrier Keyserver 112, respectively. Wireless-API 102 then sends an invoice update to a Payment System 802 in step 818, which includes the tax call, for example, an Avalara tax call. In step 822 the final signature is submitted to Blockchain 114 as a transaction. Wireless-API 102 then listens for a cleared transaction in step 824 and when the transaction clears step 828 adds an entry to the table in the Wireless Database 116 via a communication from Wireless-API 102 to Wireless Database 116. Step 830 informs Subscriber 104 they are enrolled, and in step 832, Wireless-API 102 informs Carrier Administrator 118 that Subscriber 104 is enrolled.

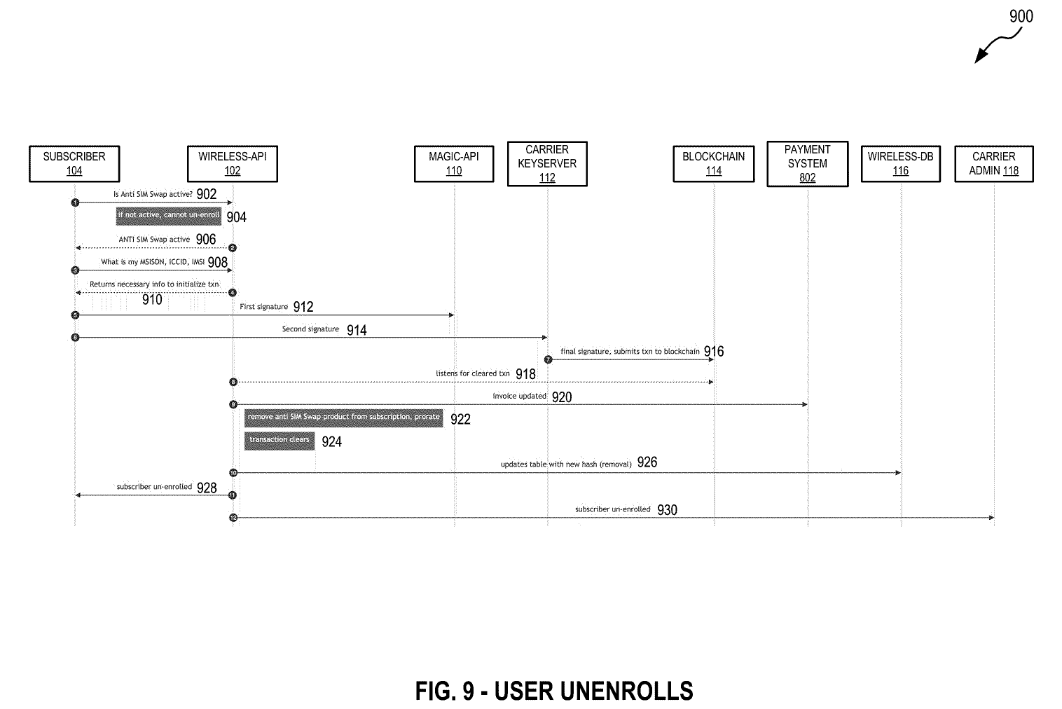

FIG. 9 shows a user un-enroll communication flow 900.

The flow starts with Subscriber 104 checking with Wireless-API 102 if Anti-SIM swap is active in step 902. If the Anti-SIM swap is not active, then Subscriber 104 cannot un-enroll and the flow ends. If the Anti-SIM swap is active, then Wireless-API 102 returns the Anti-SIM swap is active data to Subscriber 104 in step 906. In step 908 Subscriber 104 requests their MSISDN, ICCID and IMSI from Wireless-API 102 which is returned to Subscriber 104 in step 910. Subscriber 104 then sends a first signature, in step 912, and a second signature, in step 914, to the Magic-API 110 and Carrier Keyserver 112, respectively. In step 916 the final signature is submitted to Blockchain 114 as a transaction. Wireless-API 102 then listens for a cleared transaction in step 918.

When Wireless-API 102 hears a cleared transaction then it sends an invoice update to Payment System 802 in step 920. This initiates removing Anti SIM swap product from the subscription and prorates where needed in step 922 and the transaction then clears in step 924. After the transaction clears, step 926 adds and/or removes entries to/from the table in the Wireless Database 116 via Wireless-API 102 to Wireless Database communication. Step 928 informs Subscriber 104 they are un-enrolled, and, in step 930, Wireless-API 102 informs Carrier Administrator 118 that Subscriber 104 is un-enrolled.

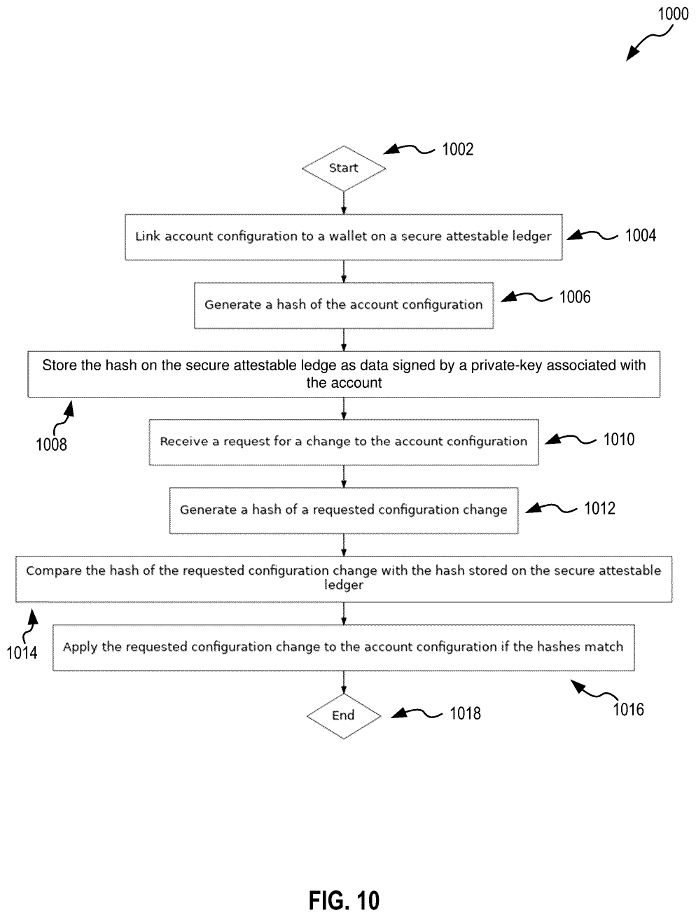

FIG. 10 shows a method 1000 for securing account information using blockchain technology.

At process start 1002 method 1000 moves to step 1004 where in links an account configuration to a wallet on a secure attestable ledger. The secure attestable ledger could be a public blockchain, a private blockchain, or a consortium blockchain. Additionally, a system could be implemented using different blockchain protocols, such as Bitcoin, Ethereum, or Hyperledger Fabric, depending on the desired levels of security, performance, and decentralization.

Once the account configuration is linked to the wallet, a hash of the account configuration is generated in step 1006. This hash is then stored on the secure attestable ledger as immutable data, signed by a private-key associated with the account in step 1008. In an embodiment, the hash may be of fixed length, regardless of the size of the input, and can be queried and compared to a requested configuration change.

Upon receiving a request for a change to the account configuration in step 1010, another hash is generated for the requested configuration change in step 1012. This new hash is then compared with the hash stored on the secure attestable ledger in step 1014. If the hashes match, the requested configuration change is applied to the account configuration in step 1016, at which point method 100 ends 1018.

This process ensures that any changes to the account configuration are pre-approved, thereby enhancing the security of the account information.

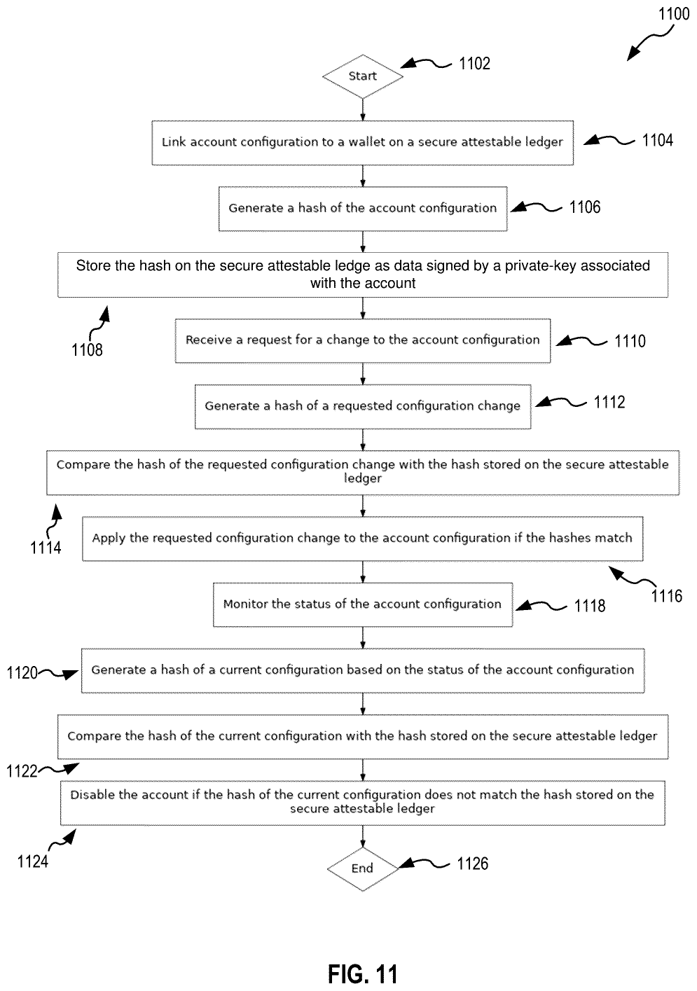

FIG. 11 shows a method 1100 for securing account information using blockchain technology is illustrated.

After method 1100 starts 1102 if moves to step 1104, where the method links an account configuration to a wallet on a secure attestable ledger. The secure attestable ledger could be a public blockchain, a private blockchain, or a consortium blockchain in some aspects. Additionally, the system could be implemented using different blockchain protocols, such as Bitcoin, Ethereum, or Hyperledger Fabric, depending on the desired levels of security, performance, and decentralization.

Once the account configuration is linked to the wallet, a hash of the account configuration is generated in step 1106. In step 1108 this hash is then stored on the secure attestable ledger as immutable data, signed by a private-key associated with the account. In an embodiment, the hash may be of fixed length, regardless of the size of the input, and can be queried and compared to a requested configuration change.

Upon receiving a request for a change to the account configuration in step 1110, another hash is generated for the requested configuration change in step 1112. This new hash is then compared with the hash stored on the secure attestable ledger in step 1112. If the hashes match, the requested configuration change is applied to the account configuration in step 1116. In step 1118 the status of the account configuration is monitored, and a new hash of the current configuration is generated in step 1120 based on the status of the account configuration. Method 1100 then compares the hash of the current configuration with the hash stored on the secure attestable ledger in step 1122. In step 1124 the account is disable if the hash of the current configuration does not match the hash stored on the secure attestable ledger. Method 1100 then ends 1126.

This process ensures that any changes to the account configuration are pre-approved, thereby enhancing the security of the account information.

In some cases, the SecureAF system also includes a monitoring system that periodically checks the status of the account configuration. This monitoring system can generate a hash of the current network observed configuration and compare it with the hash stored on the secure attestable ledger. If the hash of the current configuration does not match the hash stored on the secure attestable ledger, the account is disabled.

A number of implementations have been described. Nevertheless, it will be understood that various modifications may be made without departing from the spirit and scope of the disclosure. Accordingly, other implementations are within the scope of the following claims.

1. A method for securing account information in a mobile services system, the method comprising:
generating a hash of an account configuration;
storing the hash on a secure attestable ledger as immutable data signed by a private-key associated with the account;
receiving a request for a change to the account configuration;
generating a hash of a requested configuration change; and
comparing the hash of the requested configuration change with the hash stored on the secure attestable ledger.

2. The method of claim 1, further comprising generating a notification to an account owner when the hash of the requested configuration change does not match the hash stored on the secure attestable ledger.

3. The method of claim 1, wherein the secure attestable ledger is a blockchain.

4. The method of claim 1, wherein the hash is generated using a secure hashing algorithm.

5. The method of claim 1, wherein the account configuration includes information related to a mobile services account.

6. The method of claim 1, further comprising disabling the account if the hash of the requested configuration change does not match the hash stored on the secure attestable ledger.

7. The method of claim 1, wherein a wallet is a software wallet hosted on a user's device.

8. The method of claim 2, wherein the notification is sent via email or push notification to a mobile device.

9. The method of claim 1, wherein the account configuration includes information related to a subscriber's plan selection, billing information, MSISDN, IMSI, ICCID, owner wallet public key (pub-key), and opt-in/opt-out feature selections.

10. The method of claim 1, further comprising monitoring a status of the account configuration and generating a hash of a current configuration based on the status of the account configuration.

11. The method of claim 10, wherein if the hash of the current configuration does not match the hash stored on the secure attestable ledger, the account is disabled.

12. A system for securing account information in a mobile services system, the system comprising:
a secure attestable ledger;
a wallet linked to an account configuration;
a hash generator configured to generate a hash of the account configuration and a hash of a requested configuration change;
a storage device configured to store the hash on the secure attestable ledger as immutable data signed by a private-key associated with the account;
a request receiver configured to receive a request for a change to the account configuration;
a comparator configured to compare the hash of the requested configuration change with the hash stored on the secure attestable ledger; and
a configuration changer configured to apply the requested configuration change to the account configuration if the hash of the requested configuration change matches the hash stored on the secure attestable ledger.

13. The system of claim 12, wherein the secure attestable ledger is a blockchain.

14. The system of claim 12, wherein the hash generator is further configured to generate a hash of a current configuration based on a status of the account configuration.

15. The system of claim 14, further comprising a monitoring processor configured to monitor the status of the account configuration and to generate the hash of the current configuration.

16. The system of claim 15, wherein the monitoring processor is further configured to disable the account if the hash of the current configuration does not match the hash stored on the secure attestable ledger.

17. The system of claim 12, wherein the wallet is a software wallet, a hardware wallet, or a paper wallet.

18. A computer-implemented method for securing account information in a mobile services system, the method comprising:
linking an account configuration to a wallet on a secure attestable ledger;
generating a hash of the account configuration;
storing the hash on the secure attestable ledger as immutable data signed by a private-key associated with the account;
receiving a request for a change to the account configuration;
generating a hash of a requested configuration change;
comparing the hash of the requested configuration change with the hash stored on the secure attestable ledger; and
applying the requested configuration change to the account configuration if the hash of the requested configuration change matches the hash stored on the secure attestable ledger.

19. The method of claim 18, further comprising:
monitoring a status of the account configuration;
generating a hash of a current configuration based on the status of the account configuration;
comparing the hash of the current configuration with the hash stored on the secure attestable ledger; and
disabling the account if the hash of the current configuration does not match the hash stored on the secure attestable ledger.

20. The method of claim 19, wherein the monitoring of the status of the account configuration is performed periodically, and wherein the disabling of the account is performed within a predetermined time period after the hash of the current configuration does not match the hash stored on the secure attestable ledger.
